(19) United States
(12) Patent Application Publication
(10) Pub. No.: US 2024/0339728 A1
(43) Pub. Date: Oct. 10, 2024

(54) SEPARATOR, ELECTROCHEMICAL DEVICE, AND ELECTRONIC DEVICE

(71) Applicant: Ningde Amperex Technology Limited, Ningde (CN)

(72) Inventors: Changchuan XIONG, Ningde (CN); Bo FENG, Ningde (CN); Zengbin WEI, Ningde (CN)

(73) Assignee: Ningde Amperex Technology Limited, Ningde (CN)

(21) Appl. No.: 18/621,159

(22) Filed: Mar. 29, 2024

(30) Foreign Application Priority Data
Apr. 10, 2023 (CN) 202310369768.5

(51) Int. Cl. H01M 50/451; H01M 50/414; H01M 50/434; H01M 50/446

(52) U.S. Cl. CPC H01M 50/451; H01M 50/414; H01M 50/434; H01M 50/446

(57) ABSTRACT

A separator includes a substrate and a ceramic coating layer disposed on at least one surface of the substrate. The ceramic coating layer includes a first filler, a second filler, and a binder. A mass ratio between the first filler, the second filler, and the binder is (88.5 to 99):(0.5 to 10):(0.5 to 1.5). An ionic impedance of the ceramic coating layer is 0.001 Ω to 0.15 Ω. The separator based on the above settings exhibits a relatively low ionic impedance, indicating that the kinetic performance of the separator is improved. The separator as applied in an electrochemical device improves the kinetic performance of the electrochemical device.

### CROSS-REFERENCE TO RELATED APPLICATION

This application claims priority to the Chinese Patent Application Serial No. 202310369768.5, filed on Apr. 10, 2023, the content of which is incorporated herein by reference in its entirety.

### TECHNICAL FIELD

This application relates to the technical field of electrochemistry, and in particular, to a separator, an electrochemical device, and an electronic device.

### BACKGROUND

By virtue of the advantages such as a high energy storage density, a high open circuit voltage, a low self-discharge rate, a long cycle life, and high safety, electrochemical devices (such as a lithium-ion battery) used as a new type of portable energy storage device are widely used in various fields such as electric energy storage, mobile electronic devices, electric vehicles, and aerospace equipment.

The separator is as one of the key metrics of the performance of lithium-ion batteries. Developing a separator capable of improving the kinetic performance of the lithium-ion batteries has become a pressing technical challenge to those skilled in the art.

### SUMMARY

An objective of some embodiments of this application is to provide a separator, an electrochemical device, and an electronic device to improve the kinetic performance of the separator, and in turn, improve the kinetic performance of the electrochemical device. Specific technical solutions are as follows:

It is hereby noted that in the subject-matter hereof, this application is construed by using a lithium-ion battery as an example of an electrochemical device, but the electrochemical device according to this application is not limited to the lithium-ion battery. Specific technical solutions are as follows:

A first aspect of this application provides a separator. The separator includes a substrate and a ceramic coating layer disposed on at least one surface of the substrate. The ceramic coating layer includes a first filler, a second filler, and a binder. A mass ratio between the first filler, the second filler, and the binder is (88.5 to 99):(0.5 to 10):(0.5 to 1.5). An ionic impedance of the ceramic coating layer is 0.001Ω to 0.15Ω.

Preferably, the mass ratio between the first filler, the second filler, and the binder is (96 to 98):(1 to 3.5):(0.5 to 1.5).

Preferably, the ionic impedance of the ceramic coating layer is 0.001Ω to 0.1Ω.

In some embodiments of this application, a specific surface area of the first filler is BET₁, a specific surface area of the second filler is BET₂, and the separator satisfies at least one of the following conditions (1) to (4):(1) 5 m²/g≤BET₁≤50 m²/g; (2) 100 m²/g≤BET₂≤500 m²/g; (3) 2.5≤BET₂/BET₁≤100; or (4) a water dissolution temperature of the binder is 50° C. to 100° C.

In some embodiments of this application, the separator satisfies at least one of the following conditions (1) to (4):(1) 15 m²/g≤BET₁≤30 m²/g; (2) 150 m²/g≤BET₂≤400 m²/g; (3) 12≤BET₂/BET₁≤50; or (4) a water dissolution temperature of the binder is 50° C. to 80° C.

In some embodiments of this application, an average particle diameter of the first filler is Dv50ₐ, satisfying: 80 nm≤Dv50ₐ≤1000 nm. Preferably, 80 nm≤Dv50ₐ≤400 nm.

In some embodiments of this application, an average particle diameter of the second filler is Dv50_{b}, satisfying: 10 nm≤Dv50_{b}≤100 nm. Preferably, 15 nm≤Dv50_{b}≤50 nm.

In some embodiments of this application, a material of the first filler and a material of the second filler each independently include at least one of boehmite, aluminum oxide, zirconium oxide, titanium dioxide, magnesium oxide, mullite, silicon carbide, silicon nitride, boron nitride, or aluminum nitride; and a material of the binder includes at least one of polyvinyl alcohol, hydroxymethyl cellulose, or polyvinyl formal.

In some embodiments of this application, a bonding force of the ceramic coating layer is 30 N/m to 100 N/m, and preferably 40 N/m to 80 N/m.

In some embodiments of this application, a heat shrink ratio of the separator along a length direction of the separator is 1% to 5%, and a heat shrink ratio of the separator along a width direction of the separator is 1% to 5%.

A second aspect of this application provides an electrochemical device. The electrochemical device includes the separator according to any one of the embodiments described above.

A third aspect of this application provides an electronic device. The electronic device includes the electrochemical device according to any one of the embodiments described above.

Beneficial effects of some embodiments of this application are as follows:

An embodiment of this application provides a separator, an electrochemical device, and an electronic device. The separator includes a substrate and a ceramic coating layer disposed on at least one surface of the substrate. The ceramic coating layer includes a first filler, a second filler, and a binder. A mass ratio between the first filler, the second filler, and the binder is (88.5 to 99):(0.5 to 10):(0.5 to 1.5). An ionic impedance of the ceramic coating layer is 0.001Ω to 0.15Ω. The separator based on the above settings exhibits a relatively low ionic impedance, indicating that the kinetic performance of the separator is improved. The separator of this application applied in an electrochemical device improves the kinetic performance of the electrochemical device.

Definitely, a single product or method in which the technical solution of this application is implemented does not necessarily achieve all of the above advantages concurrently.

### BRIEF DESCRIPTION OF THE DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic cross-sectional view of a separator sectioned along a thickness direction of the separator according to some embodiments of this application;

FIG. 2 is a schematic cross-sectional view of a separator sectioned along a thickness direction of the separator according to some other embodiments of this application; and

FIG. 3 is a schematic structural diagram of a separator according to some embodiments of this application.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person of ordinary skill in the art based on the embodiments of this application without making any creative efforts still fall within the protection scope of this application.

It is hereby noted that in specific embodiments of this application, this application is construed by using a lithium-ion battery as an example of the electrochemical device, but the electrochemical device according to this application is not limited to the lithium-ion battery. Specific technical solutions are as follows:

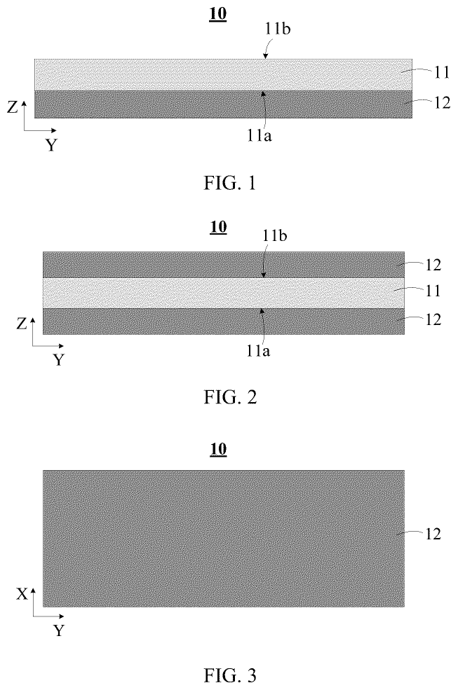

A first aspect of this application provides a separator. For ease of understanding, it is defined in this application that the width direction of the separator is X, the length direction of the separator is Y, and the thickness direction of the separator is Z. Understandably, the foregoing definitions of directions are intended for ease of describing this application. The directions defined herein may be understood with reference to the drawings and the relative positions of the elements in the actual product. Moreover, the width direction, length direction, and thickness direction of the substrate and the ceramic coating layer have the same meanings as those of the separator. As shown in FIG. 1 to FIG. 3, the separator 10 includes a substrate 11 and a ceramic coating layer 12 disposed on at least one surface of the substrate 11. The ceramic coating layer 12 includes a first filler, a second filler, and a binder. A mass ratio between the first filler, the second filler, and the binder is (88.5 to 99):(0.5 to 10):(0.5 to 1.5). An ionic impedance of the ceramic coating layer is 0.001Ω to 0.15Ω.

The mass percent of the first filler is less than 88.5%. If the mass percent is unduly low, the content of the second filler and the binder increases relatively, thereby reducing the ionic impedance of the separator and impairing the kinetics, C-rate performance, and cycle performance of the electrochemical device. If the mass percent of the first filler is higher than 99%, the mass percent is excessive, and the content of the second filler and the binder decreases relatively. The content of the second filler and the binder is not enough to bond the first filler, thereby reducing the bonding force of the ceramic coating layer, increasing the risk of detachment of the ceramic coating layer during the use of the separator, and reducing the safety performance of the electrochemical device.

For example, the ionic impedance of the ceramic coating layer is 0.001 Ω, 0.0015 Ω, 0.002 Ω, 0.003 Ω, 0.004 Ω, 0.005 Ω, 0.01 Ω, 0.03 Ω, 0.05 Ω, 0.07 Ω, 0.09 Ω, 0.11 Ω, 0.13 Ω, 0.15Ω, or a value falling within a range formed by any two thereof. When the ionic impedance of the separator falls within the above range, the ionic impedance of the separator is relatively low. In this way, the mass transfer properties of charged particles (such as lithium ions and electrons) within the positive electrode plate and the negative electrode plate, the mass transfer properties of the lithium ions in the electrolyte solution, the mass transfer properties of the lithium ions in the separator, and the mass transfer properties of the electrolyte solution in the pores between the positive/negative electrode plate and the separator in aggregate can reduce the resistance to the mass transfer of the lithium ions in the separator, thereby improving the kinetic performance of the electrochemical device.

Overall, by adjusting the mass ratio between the first filler, the second filler, and the binder in the ceramic coating layer, this application controls the ionic impedance of the ceramic coating layer to fall within the above range, thereby reducing the ionic impedance of the separator. In this way, the kinetic performance of the separator is improved. The separator of this application applied to an electrochemical device can improve the kinetic performance of the electrochemical device, and can improve the cycle performance and safety performance of the electrochemical device.

“The ceramic coating layer disposed on at least one surface of the substrate” means that the ceramic coating layer is disposed on one surface of the substrate along the thickness direction of the substrate or that the ceramic coating layer is disposed on both surfaces of the substrate along the thickness direction. As an example, as shown in FIG. 1, the separator 10 includes a substrate 11 and a ceramic coating layer 12. The ceramic coating 12 is disposed on one surface 11a of the substrate 11 along the thickness direction Z of the substrate. Definitely, the ceramic coating layer 12 may be disposed on another surface 11b of the substrate 11 along the thickness direction Z of the substrate instead. As shown in FIG. 2, the separator 10 includes a substrate 11 and a ceramic coating layer 12. The ceramic coating layer 12 is disposed on two surfaces of the substrate 11 along the thickness direction Z of the substrate.

In some embodiments of this application, a specific surface area of the first filler is BET₁, satisfying: 5 m²/g≤BET₁≤50 m²/g. For example, the specific surface area BET₁ of the first filler is 5 m²/g, 10 m²/g, 15 m²/g, 20 m²/g, 25 m²/g, 30 m²/g, 35 m²/g, 40 m²/g, 45 m²/g, 50 m²/g, or a value falling within a range formed by any two thereof. By controlling the specific surface area BET₁ of the first filler to fall within the above range, the average particle diameter of the first filler is made appropriate, thereby reducing the risk of decreasing the volumetric energy density of the electrochemical device caused by an increase in the thickness of the ceramic coating layer. During preparation of a ceramic coating slurry, due to the relatively small average particle diameter of the first filler, the risk of agglomeration of the first filler is reduced, and the first filler can be dispersed uniformly in the ceramic coating slurry. In this way, the air permeability, ionic impedance, and heat shrink ratio of the separator are made appropriate, and the kinetic performance and heat resistance of the separator are improved. Therefore, the separator of this application applied to an electrochemical device can improve the kinetic performance and thermal safety performance of the electrochemical device, and can improve the C-rate performance, cycle performance, and safety performance of the electrochemical device.

Preferably, 15 m²/g≤BET₁≤30 m²/g; For example, BET₁ is 15 m²/g, 20 m²/g, 25 m²/g, 30 m²/g, or a value falling within a range formed by any two thereof. By controlling the specific surface area BET₁ of the first filler to fall within the above preferred range, the kinetic performance and heat resistance of the separator are improved more effectively.

In some embodiments of this application, the specific surface area of the second filler is BET₂, satisfying: 100 m²/g≤BET₂≤500 m²/g. The second filler possesses a high specific surface area, thereby possessing a relatively high surface energy. The aggregation of particles of the second filler produces a bonding effect to some extent, so that the second filler serves the functions of both a filler and a binder, and can replace a majority of binders. For example, the specific surface area BET₂ of the second filler is 100 m²/g, 150 m²/g, 200 m²/g, 250 m²/g, 300 m²/g, 350 m²/g, 400 m²/g, 450 m²/g, 500 m²/g, or a value falling within a range formed by any two thereof. By controlling the specific surface area BET₂ of the second filler to fall within the above range, the second filler is of high adhesion to the first filler, the content of the binder is reduced, and the binder is less prone to form a film that adheres to and blocks a pore. Moreover, the stability of the second filler dispersed in the ceramic slurry is relatively high, thereby exerting the functions of the second filler more effectively. In this way, the ionic impedance and heat shrink ratio of the separator are relatively low, and the kinetics of the separator are reduced. The kinetic performance and heat resistance of the separator are improved. Therefore, the separator of this application applied to an electrochemical device can improve the kinetic performance and thermal safety performance of the electrochemical device, and can improve the C-rate performance, cycle performance, and safety performance of the electrochemical device.

Preferably, 150 m²/g≤BET₂≤400 m²/g. For example, BET₂ is 150 m²/g, 200 m²/g, 250 m²/g, 300 m²/g, 350 m²/g, 400 m²/g, or a value falling within a range formed by any two thereof. By controlling the specific surface area BET₂ of the second filler to fall within the above preferred range, the kinetic performance and heat resistance of the separator are improved more effectively.

In some embodiments of this application, 2.5≤BET₂/BET₁≤100. For example, the BET₂/BET₁ ratio is 2.5, 10, 20, 30, 40, 50, 60, 70, 80, 90, 100, or a value falling within a range formed by any two thereof. By controlling the BET₂/BET₁ ratio to fall within the above range, the second filler is of high adhesion to the first filler, the content of the binder is reduced, and the binder is less prone to form a film that adheres to and blocks a pore. Moreover, the stability of the second filler dispersed in the ceramic slurry is relatively high, thereby exerting the functions of the second filler more effectively. In this way, the ionic impedance and heat shrink ratio of the separator are relatively low, and the kinetics of the separator are reduced. The kinetic performance and heat resistance of the separator are improved. Therefore, the separator of this application applied to an electrochemical device can improve the kinetic performance and thermal safety performance of the electrochemical device, and can improve the C-rate performance, cycle performance, and safety performance of the electrochemical device.

Preferably, 12≤BET₂/BET₁≤50. For example, the BET₂/BET₁ ratio is 12, 20, 30, 40, 50, or a value falling within a range formed by any two thereof. By controlling the BET₂/BET₁ ratio to fall within the above preferred range, the kinetic performance and heat resistance of the separator are improved more effectively.

In some embodiments of this application, a water dissolution temperature of the binder is 50° C. to 100° C. For example, the water dissolution temperature of the binder is 50° C., 60° C., 70° C., 80° C., 90° C., 100° C., or a value falling within a range formed by any two thereof. By controlling the water dissolution temperature of the binder to fall within the above range, this application reduces the risk of detachment of the ceramic coating layer caused by dissolution of the binder in the ceramic coating layer of the separator during preparation of the separator, and reduces the risk that the binder dissolved for a second time forms a film and blocks a pore. In addition, the energy consumed by the binder during dissolution is relatively low, thereby reducing the processing cost of the electrochemical device. Therefore, the separator is of high processability in addition to good kinetic performance and high heat resistance.

Preferably, the water dissolution temperature of the binder is 50° C. to 80° C. For example, the water dissolution temperature of the binder is 50° C., 55° C., 60° C., 70° C., 80° C., or a value falling within a range formed by any two thereof. When the water dissolution temperature of the binder is controlled to fall within the above preferred range, the separator is of higher processability in addition to good kinetic performance and high heat resistance.

The method for adjusting and controlling the water dissolution temperature of the binder is not particularly limited herein, as long as the objectives of this application can be achieved. For example, the water dissolution temperature of the binder may be controlled by selecting different types of binders, adjusting the alcoholysis degree of the binder material, or the like. In some embodiments, the alcoholysis degree of the binder is 80% to 99%.

In some embodiments of this application, an average particle diameter of the first filler is Dv50ₐ, satisfying: 80 nm≤Dv50ₐ≤1000 nm. Preferably, 80 nm≤Dv50ₐ≤400 nm. For example, the average particle diameter Dv50ₐ of the first filler is 80 nm, 100 nm, 200 nm, 300 nm, 400 nm, 500 nm, 600 nm, 700 nm, 800 nm, 900 nm, 1000 nm, or a value falling within a range formed by any two thereof. When the average particle diameter Dv50ₐ of the first filler is controlled to fall within the above range, the specific surface area BET₁ of the first filler can be favorably maintained within the range specified herein, and the stacking density of particles of the first filler can be increased. In this way, the structural stability of the ceramic coating layer is improved, the probability of shrinkage of the separator subjected to heat is reduced, and therefore, the heat resistance of the separator is improved.

In some embodiments of this application, an average particle diameter of the second filler is Dv50_{b}, satisfying: 10 nm≤Dv50_{b}≤100 nm. Preferably, 15 nm≤Dv50_{b}≤50 nm. For example, the average particle diameter Dv50_{b} of the second filler is 10 nm, 15 nm, 20 nm, 30 nm, 40 nm, 50 nm, 60 nm, 70 nm, 80 nm, 90 nm, 100 nm, or a value falling within a range formed by any two thereof. When the average particle diameter Dv50_{b} of the second filler is controlled to fall within the above range, the specific surface area BET₂ of the second filler can be favorably maintained within the range specified herein. In this way, the second filler plays the roles of both a filler and a binder, and reduces the dosage of the binder, thereby making the binder less prone to form a film and block a pore, increasing the bonding strength of the ceramic coating layer at high temperature, and in turn, reducing the ionic impedance of the separator, and improving the heat resistance of the separator. In this way, the kinetic performance and the heat resistance of the separator are improved.

In this application, Dv50ₐ represents a particle diameter value at which the cumulative volume percentage of the particles of the first filler reaches 50% in a volume-based particle size distribution curve viewed from a small-diameter side. In this application, Dv50_{b} represents a particle diameter value at which the cumulative volume percentage of the particles of the second filler reaches 50% in a volume-based particle size distribution curve viewed from a small-diameter side.

The methods for adjusting and controlling the specific surface areas of the first filler and the second filler as well as the average particle diameter are not particularly limited herein, as long as the objectives of this application can be achieved. For example, the following two methods may apply: (1) adjusting the particle size during the synthesis of the first filler and the second filler, and controlling the specific surface areas of the first filler and the second filler at the same time; (2) changing the reaction conditions (for example, temperature, pressure, agents, and the like) during the synthesis of the first filler and the second filler to control the growth rate of the particles of the first filler and the second filler, so as to control the surface sparseness of the particles of the first filler and the second filler, and in turn, control the specific surface area of the particles of the first filler and the second filler.

The thickness of the ceramic coating layer is not particularly limited herein, as long as the objectives of this application can be achieved. For example, the thickness of the ceramic coating layer is 0.2 μm to 2 μm.

In some embodiments of this application, the material of the first filler and the material of the second filler each independently include at least one of boehmite, aluminum oxide, zirconium oxide, titanium dioxide, magnesium oxide, mullite, silicon carbide, silicon nitride, boron nitride, or aluminum nitride. The type of material of the first filler may be the same as or different from that of the second filler. The material of the binder includes at least one of polyvinyl alcohol, hydroxymethyl cellulose, or polyvinyl formal. The above type of filler is of high hardness, electrochemical stability, and heat resistance. The above type of binder is of high adhesion and heat resistance. The above types of first filler, second filler, and binder in use can reduce the ionic impedance and heat shrink ratio of the separator, thereby improving the kinetic performance and heat resistance of the separator.

In some embodiments of this application, a bonding force of the ceramic coating layer is 30 N/m to 100 N/m, and preferably 40 N/m to 80 N/m. For example, the bonding force of the ceramic coating layer is 30 N/m, 40 N/m, 50 N/m, 60 N/m, 70 N/m, 80 N/m, 90 N/m, 100 N/m, or a value falling within a range formed by any two thereof. The ceramic coating layer with a bonding force falling within the above range is of high adhesion, thereby reducing the risk of detachment of the ceramic coating layer. Such a separator applied to an electrochemical device endows the electrochemical device with good safety performance.

In some embodiments of this application, an air permeability of the ceramic coating layer is 5 s/100 cc to 20 s/100 cc. For example, the air permeability of the ceramic coating layer is 5 s/100 cc, 8 s/100 cc, 11 s/100 cc, 14 s/100 cc, 17 s/100 cc, 20 s/100 cc, or a value falling within a range formed by any two thereof. The ceramic coating layer with an air permeability falling within the above range is of a relatively low permeability, thereby being well-balanced in porosity and permeability. In this way, the separator is of a relatively low ionic impedance, thereby facilitating conduction of lithium ions in the electrochemical device, and in turn, improving the kinetic performance of the electrochemical device.

In some embodiments of this application, a heat shrink ratio of the separator along a length direction of the separator is 1% to 5%, and a heat shrink ratio of the separator along a width direction of the separator is 1% to 5%. For example, the heat shrink ratio of the separator along the length direction of the separator is 1%, 2%, 3%, 4%, 5%, or a value falling within a range formed by any two thereof. The heat shrink ratio of the separator along the width direction of the separator is 1%, 2%, 3%, 4%, 5%, or a value falling within a range formed by any two thereof. The thermal safety performance of the electrochemical device primarily means the ability of the electrochemical device to avoid thermal runaway when the electrochemical device is heated by the internally generated heat or an external environment. The separator in the electrochemical device isolates the positive electrode plate from the negative electrode plate to avoid thermal runaway caused by an internal short circuit. In this application, the separator with a heat shrink ratio along the length direction and a heat shrink ratio along the width direction of the separator possesses a relatively low heat shrink ratio. This reduces the risk of short-circuiting of the electrochemical device caused by the contact between the positive electrode plate and the negative electrode plate as a result of heat shrinkage of the separator, thereby reducing the risk of thermal runaway of the electrochemical device. By this means, the thermal safety performance of the electrochemical device is improved.

In some embodiments of this application, the substrate includes at least one of polyethylene, polypropylene, polyvinylidene difluoride, polyimide, polyether ether ketone, poly(p-phenylene terephthalamide), polyethylene terephthalate, poly(phthalimide ether sulfone ketone), polyisophthalamide, cellulose, or a mixture thereof. The mixture includes, but is not limited to, cotton fibers, glass fibers, aramid fibers, and wood fibers. The above types of substrates are more conducive to transport of the electrolyte solution, and make the separator more infiltrated by and more absorptive of the electrolyte solution, thereby improving the cycle performance and safety performance of the secondary battery.

The conventional parameters such as porosity and thickness of the substrate are not particularly limited herein, as long as the objectives of this application can be achieved. For example, the thickness of the substrate is 2 μm to 7 μm.

The method for preparing the separator is not particularly limited herein, as long as the objectives of this application can be achieved. For example, the separator may be prepared by the following steps:
(1) Mixing well the first filler, the second filler, and the binder of this application at the mass percent specified herein to formulate a ceramic coating slurry in which the solid content is 10 wt % to 50 wt %; and
(2) Applying the ceramic coating slurry to at least one surface of the substrate, and oven-drying the slurry to obtain a separator.

A second aspect of this application provides an electrochemical device. The electrochemical device includes the separator according to any one of the embodiments described above. Therefore, the electrochemical device exhibits good kinetic performance and thermal safety performance.

In some embodiments of this application, the electrochemical device includes a pocket, an electrode assembly, and an electrolyte solution. The electrode assembly and the electrolyte solution are accommodated in the pocket. The structure of the electrode assembly is not particularly limited in this application, as long as the objectives of this application can be achieved. For example, the structure of the electrode assembly is a stacked structure or a jelly-roll structure. The electrode assembly includes a positive electrode plate, a negative electrode plate, and the separator disclosed in any one of the above technical solutions of this application. The separator is disposed between the positive electrode plate and the negative electrode plate.

In this application, the positive electrode plate is not particularly limited, as long as the objectives of this application can be achieved. For example, the positive electrode plate includes a positive current collector and a positive active material layer. The positive current collector is not particularly limited in this application, as long as the objectives of this application can be achieved. For example, the positive current collector may include aluminum foil, aluminum alloy foil, a composite current collector, or the like. The positive active material layer in this application includes a positive active material. The type of the positive active material is not particularly limited in this application, as long as the objectives of this application can be achieved. For example, the positive active material may include at least one of lithium nickel cobalt manganese oxide (such as NCM811, NCM622, NCM523, NCM111), lithium nickel cobalt aluminum oxide, lithium iron phosphate, a lithium-rich manganese-based material, lithium cobalt oxide (LiCoO₂), lithium manganese oxide, lithium manganese iron phosphate, lithium titanium oxide, or the like. In this application, the positive active material may further include a non-metallic element. For example, the non-metallic elements include at least one of fluorine, phosphorus, boron, chlorine, silicon, or sulfur. Such elements can further improve the stability of the positive active material. In this application, the thicknesses of the positive current collector and the positive active material layer are not particularly limited, as long as the objectives of this application can be achieved. For example, the thickness of the positive current collector is 5 μm to m, and preferably 6 μm to 18 μm. The thickness of the positive active material layer on a single side is 30 μm to 120 μm. In this application, the positive active material layer may be disposed on one surface of the positive current collector in a thickness direction or on both surfaces of the positive current collector in the thickness direction. Optionally, the positive active material layer may further include a conductive agent and a binder. The types of the conductive agent and the binder in the positive active material are not particularly limited herein, as long as the objectives of this application can be achieved. The mass percentages of the positive active material, conductive agent, or binder in the positive active material layer are not particularly limited herein, and may be selected by a person skilled in the art as actually required, as long as the objectives of this application can be achieved. For example, the mass ratio between the positive active material, the conductive agent, and the binder in the positive active material layer is (97.5 to 97.9):(0.8 to 1.7):(1.0 to 2.0).

In this application, the negative electrode plate is not particularly limited, as long as the objectives of this application can be achieved. For example, the negative electrode plate includes a negative current collector and a negative active material layer. The negative current collector is not particularly limited in this application, as long as the objectives of this application can be achieved. For example, the negative current collector may include a copper foil, copper alloy foil, nickel foil, stainless steel foil, titanium foil, foamed nickel, foamed copper, or the like. The negative active material layer in this application includes a negative active material. The type of the negative active material is not particularly limited in this application, as long as the objectives of this application can be achieved. For example, the negative active material may include at least one of natural graphite, artificial graphite, mesocarbon microbeads (MCMB), hard carbon, soft carbon, silicon, a silicon-carbon composite, SiOₓ(0<x<2), Li—Sn alloy, Li—Sn—O alloy, Sn, SnO, SnO₂, spinel-structured lithium titanium oxide Li₄Ti₅O₁₂, Li—Al alloy, or metallic lithium. The thicknesses of the negative current collector and the negative active material layer are not particularly limited herein, as long as the objectives of this application can be achieved. For example, the thickness of the negative current collector is 6 μm to 10 μm, and the thickness of the negative active material layer is 30 μm to 130 μm. Optionally, the negative active material layer may further include at least one of a conductive agent, a stabilizer, and a binder. The types of the conductive agent, stabilizer, and binder in the negative active material are not particularly limited herein, as long as the objectives of this application can be achieved. The mass percentages of the negative active material, conductive agent, stabilizer, and binder in the negative active material layer are not particularly limited herein, as long as the objectives of this application can be achieved. For example, the mass ratio between the negative active material, conductive agent, stabilizer, and binder in the negative active material layer is (97 to 98):(0.5 to 1.5):(0 to 1.5):(1.0 to 1.9).

The pocket and the electrolyte solution are not particularly limited herein, and may be a pocket and electrolyte solution well-known in the art, as long as the objectives of this application can be achieved.

The type of the electrochemical device is not particularly limited herein, and may be any device in which an electrochemical reaction occurs. For example, the electrochemical device may include, but is not limited to, a lithium metal secondary battery, a lithium-ion secondary battery (lithium-ion battery), a sodium-ion secondary battery (sodium-ion battery), a lithium polymer secondary battery, a lithium-ion polymer secondary battery.

The method for preparing the electrochemical device is not particularly limited herein, and may be any preparation method well-known in the art, as long as the objectives of this application can be achieved. For example, the method for preparing the electrochemical device includes, but is not limited to, the following steps: stacking the positive electrode plate, the separator, and the negative electrode plate in sequence, and performing operations such as winding and folding as required to obtain a jelly-roll electrode assembly; putting the electrode assembly into a package, injecting the electrolyte solution into the package, and sealing the package to obtain an electrochemical device; or, stacking the positive electrode plate, the separator, and the negative electrode plate in sequence, and then fixing the four corners of the entire stacked structure to obtain a stacked-type electrode assembly, putting the electrode assembly into a package, injecting the electrolyte solution into the package, and sealing the package to obtain an electrochemical device.

A third aspect of this application provides an electronic device. The electronic device includes the electrochemical device according to any one of the embodiments described above. Therefore, the electronic device exhibits good kinetic performance and thermal safety performance.

The electronic device is not particularly limited herein, and may be any electronic device known in the prior art. For example, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household battery, or lithium-ion capacitor.

### EMBODIMENTS

The implementations of this application are described below in more detail with reference to embodiments and comparative embodiments. Various tests and evaluations are performed by the following methods.

### Test Methods and Devices

### Testing the Kinetic Performance of a Lithium-Ion Battery:

1. Testing the direct current resistance (DCR) of a lithium-ion battery: first, applying a constant current (I) of 10 A mandatorily to the lithium-ion battery in each embodiment and each comparative embodiment for a short time of 1 s, during which the voltage of the lithium-ion battery varies over time, with the variation of voltage denoted as AU; subsequently, calculating the direct-current resistance of the lithium-ion battery according to Ohm's law R=ΔU/I. The direct current resistances in all embodiments and Comparative Embodiments 2 to 4 are denoted as R₂, and the direct current resistance in Comparative Embodiment 1 is denoted as R₁.

The decrease in the direct current resistance is ΔR=R₂−R₁.

2. Testing the low-temperature discharge performance (HL Temp) of a lithium-ion battery: first, charging a lithium-ion battery at a constant current of 1 C to make the lithium-ion battery fully charged; second, putting the lithium-ion battery in a low-temperature test chamber, cooling down to −20° C., discharging the battery until the voltage drops to 3 V, and then recording the discharge capacity Q of the lithium-ion battery (the discharge capacities in all embodiments and Comparative Embodiments 2 to 4 are denoted as Q₂, and the discharge capacity in Comparative Embodiment 1 is denoted as Q₁), that is, the low-temperature discharge capacity of the lithium-ion battery.

Low-temperature discharge performance improvement rate (%)=[(Q₂−Q₁)/Q₁]×100%.

The kinetic performance of the lithium-ion battery is represented by both the direct current resistance decrement ΔR and the low-temperature discharge performance improvement rate of the lithium-ion battery. The larger the direct current resistance decrement ΔR and the low-temperature discharge performance improvement rate, the higher the kinetic performance of the lithium-ion battery.

### Testing the Thermal Safety Performance of a Lithium-Ion Battery:

Hot box test for the lithium-ion battery: first, charging a lithium-ion battery at a current of 1.5 C until the battery is fully charged; second, putting the fully charged lithium-ion battery into an oven, increasing the temperature to 135° C. at a rate of 5° C./min, and keeping the temperature for 1 hour. Determining that the lithium-ion battery passes the test if the battery does not catch fire or explode. From each embodiment and each comparative embodiment, 100 lithium-ion batteries are taken for testing. The hot box test pass rate is calculated as: the number of batteries passing the test/100×100%. The thermal safety performance of the lithium-ion battery is represented by the hot box test pass rate. The higher the hot box test pass rate, the higher the thermal safety performance of the lithium-ion battery.

### Testing the Specific Surface Area:

Testing the specific surface area by using a BSD-660 high-performance specific surface area and pore size analyzer.

### Testing the Average Particle Diameter:

Testing the average particle diameter by using a Malvern high-sensitivity nanoscale particle size analyzer (Malvern Mastersizer 3000).

### Testing the Bonding Force of the Ceramic Coating Layer:

Testing the bonding force of the ceramic coating layer to the substrate by using a coating adhesion test method with reference to the national standard GB/T 5210-1985. Cutting a prepared separator into small strips of 15 mm×54.2 mm in size, and testing the bonding force with reference to the national standard GB/T 5210-1985 to determine the adhesion of the coating layer.

### Testing the Air Permeability of the Ceramic Coating Layer:

Using a Gurley automatic permeability tester to measure the permeability of the substrate (denoted as G₁) and the permeability of the separator overlaid with a ceramic coating layer (denoted as G₂) separately. The air permeability of the ceramic coating layer is calculated as (G₂−G₁).

### Testing the Ionic Impedance:

Testing the ionic impedance of the ceramic coating layer by using electrochemical impedance spectroscopy (EIS). Specifically, measuring the impedance of the substrate, and then measuring the impedance of the separator, and calculating a difference between the two measured values as the impedance of the ceramic coating layer.

### Testing the Heat Shrink Ratio:

Stamping the separators in each embodiment and each comparative embodiment into specimens of 72.5 mm (length)×54.2 mm (width) in size, putting a specimen flat between two sheets of A4 paper, and then leaving the specimen in a 150° constant-temperature oven to stand for 1 hour. Taking the specimen out upon completion of the baking, recording the measured length as X₁, and recording the measured width as X₂. If the specimen shrinks unevenly at the edge, the dimensions of a maximally shrunk position prevail.

$$Heat shrink ratio in the length direction {T}_{1} = ( 72.5 - {X}_{1} ) / 72.5 \times 100 \% ;$$

$$Heat shrink ratio in the width direction {T}_{2} = ( 54.2 - {X}_{2} ) / 54.2 \times 100 \% .$$

### Embodiment 1-1

### <Preparing a Separator>

Pre-dissolving the binder: Weighing out an amount of a binder powder polyvinyl alcohol (alcoholysis degree: 93%; water dissolution temperature: 65° C.) and an amount of deionized water to formulate a binder solution in which the solid content is 10 wt %. Adding the deionized water into a dissolution and agitation tank. Adding the binder powder into the tank while stirring the mixture in the tank at the same time. Upon completion of adding all the binder powder, starting to heat the dissolution and agitation tank by use of a jacket at a heating rate of 5° C./min to heat and dissolve the binder powder until the temperature is a 10° C. above the dissolution temperature of the binder, and then keeping the temperature for 60 minutes to ensure sufficient dissolution. Finally, naturally cooling down the pre-dissolved binder to a room temperature for further use.

Mixing well the first filler boehmite, the second filler aluminum oxide, and the pre-dissolved binder at a mass ratio of 98:1:1 to obtain a ceramic coating slurry in which the solid content is 40 wt %. Applying the ceramic coating slurry onto one surface of the substrate, and oven-drying the slurry at 40° C. to obtain a ceramic coating layer that is 1 μm thick as a single layer, so that the separator is produced.

The specific surface area BET₁ of the first filler is 20 m²/g, and the average particle diameter Dv50ₐ of the first filler is 100 nm. The specific surface area BET₂ of the second filler is 300 m²/g, and the average particle diameter Dv50_{b} of the second filler is 20 nm.

The substrate is 5 m-thick polyethylene (PE for short, with a weight-average molecular weight of 30 W).

### <Preparing a Positive Electrode Plate>

Mixing LiCoO₂ as a positive active material, acetylene black as a conductive agent, and polyvinylidene difluoride (PVDF) as a binder at a mass ratio of 97.5:0.8:1.7, adding N-methyl-pyrrolidone (NMP) as a solvent, and stirring the mixture with a vacuum mixer until the system is homogeneous, so as to obtain a positive electrode slurry in which the solid content is 75 wt %. Coating one surface of a 10 μm-thick positive current collector aluminum foil with the positive electrode slurry evenly, and drying the slurry in a 90° C. environment to obtain a positive electrode plate coated with a 110 μm-thick positive active material layer on a single side. Subsequently, repeating the foregoing steps on the other surface of the aluminum foil to obtain a positive electrode plate coated with the positive active material layer on both sides. Performing cold-pressing, cutting, and tab welding to obtain a positive electrode plate of 74 mm×867 mm in size for further use.

### <Preparing a Negative Electrode Plate>

Mixing graphite as a negative active material, conductive carbon black (Super P) as a conductive agent, and styrene-butadiene rubber (SBR, with a weight-average molecular weight of 20 W) as a binder at a mass ratio of 97.8:0.7:1.5, and then adding deionized water as a solvent; and mixing the solution with a vacuum mixer to formulate a homogeneous negative electrode slurry in which the solid content is 50 wt %. Applying the negative electrode slurry evenly onto one surface of an 8 μm-thick negative current collector copper foil, and drying the foil at 65° C. to obtain a negative electrode plate coated with a 130 μm-thick negative active material layer on a single side. Subsequently, repeating the foregoing steps on the other surface of the copper foil to obtain a negative electrode plate coated with the negative active material layer on both sides. Performing cold-pressing, cutting, and tab welding to obtain a negative electrode plate of 76 mm×851 mm in size for further use.

### <Preparing an Electrolyte Solution>

Mixing ethylene carbonate (EC), diethyl carbonate (DEC), propylene carbonate (PC), propyl propionate (PP), and vinylene carbonate (VC) at a mass ratio of 20:30:20:28:2 in an environment with a moisture content less than 10 ppm, so as to obtain a nonaqueous organic solution. Adding lithium hexafluorophosphate (LiPF₆) into the nonaqueous organic solvent to dissolve, and stirring well to obtain an electrolyte solution, in which the concentration of LiPF₆ is 1 mol/L.

### <Preparing a Lithium-Ion Battery>

Stacking the above-prepared negative electrode plate, separator, and positive electrode plate sequentially, and winding the stacked structure to obtain a jelly-roll electrode assembly, in which the ceramic coating layer of the separator is adjacent to the positive electrode plate. Putting the electrode assembly into an aluminum plastic film package, drying the packaged electrode assembly, and then injecting the electrolyte solution. Performing steps such as vacuum sealing, static standing, chemical formation, degassing, and edge trimming to obtain a lithium-ion battery. The upper-limit voltage of the chemical formation is 4.5 V, the temperature of the chemical formation is 75° C., and the static standing time in the chemical formation is 2 hours.

### Embodiments 1-2 to 1-4

Identical to Embodiment 1-1 except that the relevant preparation parameters are adjusted according to Table 1.

### Embodiment 1-5

### <Preparing a Separator>

Mixing well the first filler boehmite, the second filler aluminum oxide, and the pre-dissolved binder at a mass ratio of 96:3.5:0.5 to obtain a ceramic coating slurry in which the solid content is 40 wt %. Applying the ceramic coating slurry onto both surfaces of the substrate, and oven-drying the slurry at 40° C. to obtain a ceramic coating layer that is 1 μm thick as a single layer, so that the separator is produced.

The rest is the same as that in Embodiment 1-1.

### Embodiments 1-6 to 1-9

Identical to Embodiment 1-5 except that the relevant preparation parameters are adjusted according to Table 1.

### Embodiment 1-10

Identical to Embodiment 1-1 except that the relevant preparation parameters are adjusted according to Table 1.

### Embodiments 1-11 to 1-12

Identical to Embodiment 1-1 except that the relevant preparation parameters are adjusted according to Table 1.

### Embodiments 2-1 to 2-2

Identical to Embodiment 1-3 except that the relevant preparation parameters are adjusted according to Table 2.

### Embodiment 2-3

Identical to Embodiment 1-2 except that the relevant preparation parameters are adjusted according to Table 2.

### Embodiments 2-4 to 2-7

Identical to Embodiment 1-3 except that the relevant preparation parameters are adjusted according to Table 2.

### Embodiments 2-8 to 2-34

Identical to Embodiment 2-3 except that the relevant preparation parameters are adjusted according to Table 2.

### Embodiments 3-1 to 3-6

Identical to Embodiment 2-3 except that the relevant preparation parameters are adjusted according to Table 3.

### Comparative Embodiments 1 to 5

Identical to Embodiment 1-1 except that the relevant preparation parameters are adjusted according to Table 1.

Table 1 to Table 4 show the preparation parameters and performance parameters of the embodiments and comparative embodiments.

TABLE 1

| | Mass | | | | | | | | |
|---|---|---|---|---|---|---|---|---|---|
| | ratio | | | | | | | | |
| | between | | | | | | | Low- | |
| | first | | | | | | | temperature | Hot |
| | filler, | | | | | | | discharge | box |
| | second | | | | | | | performance | test |
| | filler, | Bonding | Air | Ionic | | | | improvement | pass |
| | and | force | permeability | impedance | T₁ | T₂ | ΔR | rate | rate |
| | binder | (N/m) | (s/cc) | (Ω) | (%) | (%) | (mΩ) | (%) | (%) |
| Embodiment | 98:1:1 | 40 | 13 | 0.05 | 3.2 | 3.2 | 6.2 | 13 | 93 |
| 1-1 | | | | | | | | | |
| Embodiment | 97.2:2:0.8 | 65 | 4 | 0.001 | 2.2 | 2.3 | 14 | 22 | 100 |
| 1-2 | | | | | | | | | |
| Embodiment | 97:2:1 | 67 | 5.6 | 0.0015 | 2.5 | 2.1 | 13 | 21 | 100 |
| 1-3 | | | | | | | | | |
| Embodiment | 96.7:2:1.3 | 69 | 9 | 0.008 | 2.5 | 2.3 | 11 | 18 | 100 |
| 1-4 | | | | | | | | | |
| Embodiment | 96:3.5:0.5 | 65 | 9.5 | 0.009 | 2.5 | 2.7 | 10.5 | 17 | 100 |
| 1-5 | | | | | | | | | |
| Embodiment | 95.5:3:1.5 | 90 | 16 | 0.12 | 3.9 | 3.7 | 4.6 | 8 | 87 |
| 1-6 | | | | | | | | | |
| Embodiment | 95:4:1 | 80 | 17 | 0.1 | 3.8 | 3.8 | 4.8 | 8.1 | 88.5 |
| 1-7 | | | | | | | | | |
| Embodiment | 88.5:10:1.5 | 100 | 20 | 0.15 | 3.9 | 3.9 | 4.3 | 7.7 | 85 |
| 1-8 | | | | | | | | | |
| Embodiment | 99:0.5:0.5 | 30 | 12 | 0.06 | 3.3 | 3.2 | 6 | 10 | 92 |
| 1-9 | | | | | | | | | |
| Embodiment | 96:3.5:0.5 | 60 | 8.5 | 0.007 | 2.7 | 2.8 | 11.5 | 18.5 | 100 |
| 1-10 | | | | | | | | | |
| Embodiment | 98.5:0.8:0.7 | 35 | 12.6 | 0.055 | 2.9 | 3.1 | 5.9 | 12.2 | 92.4 |
| 1-11 | | | | | | | | | |
| Embodiment | 94:5:1 | 93 | 15.5 | 0.13 | 3.8 | 3.9 | 4.5 | 7.8 | 86 |
| 1-12 | | | | | | | | | |
| Comparative | 88:11:1 | 27 | 22 | 0.19 | 7.7 | 7.8 | 0 | 0 | 74 |
| Embodiment | | | | | | | | | |
| 1 | | | | | | | | | |
| Comparative | 99.5:0.25:0.25 | 21 | 29 | 0.32 | 10.0 | 11.0 | 0.8 | 1 | 62 |
| Embodiment | | | | | | | | | |
| 2 | | | | | | | | | |
| Comparative | 99:0:1 | 23 | 32 | 0.45 | 15.0 | 16.0 | 0.6 | 0.5 | 45 |
| Embodiment | | | | | | | | | |
| 3 | | | | | | | | | |
| Comparative | 99:1:0 | 15 | 24 | 0.26 | 9.5 | 9.5 | 0.7 | 2.2 | 68 |
| Embodiment | | | | | | | | | |
| 4 | | | | | | | | | |
| Comparative | 97:1:2 | 105 | 25 | 0.28 | 9.8 | 10.1 | 0.9 | 2 | 65 |
| Embodiment | | | | | | | | | |
| 5 | | | | | | | | | |

Note: “┘” in Table 1 represents absence of the relevant preparation parameter; and Embodiment 1-5 differs from Embodiment 1-10 in that the ceramic coating layer in Embodiment 1-5 is disposed on both surfaces of the substrate, and the ceramic coating layer in Embodiment 1-10 is disposed on one surface of the substrate.

As can be seen from Embodiments 1-1 to 1-12 and Comparative Embodiments 1 to 5, the separator in embodiments of this application is of high adhesion and lower air permeability, ionic impedance, and heat shrink ratio; and the lithium-ion batteries achieve a larger decrease in the direct current resistance, a higher low-temperature discharge performance improvement rate, and a higher hot box test pass rate, indicating that the kinetic performance and thermal safety performance of the electrochemical device are improved. In contrast, in Comparative Embodiments 1 to 5, the separator is of lower adhesion and higher air permeability, ionic impedance, and heat shrink ratio; and the lithium-ion batteries achieve a smaller decrease in the direct current resistance, a lower low-temperature discharge performance improvement rate, and a lower hot box test pass rate, indicating that the kinetic performance and thermal safety performance of the electrochemical device are inferior.

Whether the ceramic coating layer is disposed on one surface or both surfaces of the substrate usually also affects the kinetic performance and heat resistance of the separator. As can be seen from Embodiments 1-5 and 1-10, the separator containing a ceramic coating layer that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

TABLE 2

| | Mass | | | | | | | |
|---|---|---|---|---|---|---|---|---|
| | ratio | | | | | | | |
| | between | | | | | | | |
| | first | | | | | | | |
| | filler, | | | | | | | Water |
| | second | | | | | | | dissolution |
| | filler, | | | | | | | temperature |
| | and | BET₁ | Dv50ₐ | BET₂ | Dv50_{b} | | | of binder |
| | binder | (m²/g) | (nm) | (m²/g) | (nm) | BET₂/BET₁ | Binder | (° C.) |
| Embodiment | 97.2:2:0.8 | 20 | 100 | 300 | 20 | 15 | Polyvinyl | 65 |
| 1-2 | | | | | | | alcohol | |
| | | | | | | | (alcoholysis | |
| | | | | | | | degree = | |
| | | | | | | | 93%) | |
| Embodiment | 97:2:1 | 20 | 100 | 300 | 20 | 15 | Polyvinyl | 65 |
| 1-3 | | | | | | | alcohol | |
| | | | | | | | (alcoholysis | |
| | | | | | | | degree = | |
| | | | | | | | 93%) | |
| Embodiment | 97:2:1 | 20 | 100 | 300 | 20 | 15 | Polyvinyl | 50 |
| 2-1 | | | | | | | alcohol | |
| | | | | | | | (alcoholysis | |
| | | | | | | | degree = | |
| | | | | | | | 90%) | |
| Embodiment | 97:2:1 | 20 | 100 | 300 | 20 | 15 | Polyvinyl | 55 |
| 2-2 | | | | | | | alcohol | |
| | | | | | | | (alcoholysis | |
| | | | | | | | degree = | |
| | | | | | | | 91%) | |
| Embodiment | 97.2:2:0.8 | 20 | 100 | 300 | 20 | 15 | Polyvinyl | 70 |
| 2-3 | | | | | | | alcohol | |
| | | | | | | | (alcoholysis | |
| | | | | | | | degree = | |
| | | | | | | | 93.5%) | |
| Embodiment | 97:2:1 | 20 | 100 | 300 | 20 | 15 | Polyvinyl | 70 |
| 2-4 | | | | | | | alcohol | |
| | | | | | | | (alcoholysis | |
| | | | | | | | degree = | |
| | | | | | | | 93.5%) | |
| Embodiment | 97:2:1 | 20 | 100 | 300 | 20 | 15 | Polyvinyl | 80 |
| 2-5 | | | | | | | alcohol | |
| | | | | | | | (alcoholysis | |
| | | | | | | | degree = | |
| | | | | | | | 96%) | |
| Embodiment | 97:2:1 | 20 | 100 | 300 | 20 | 15 | Polyvinyl | 90 |
| 2-6 | | | | | | | alcohol | |
| | | | | | | | (alcoholysis | |
| | | | | | | | degree = | |
| | | | | | | | 97.5%) | |
| Embodiment | 97:2:1 | 20 | 100 | 300 | 20 | 15 | Polyvinyl | 100 |
| 2-7 | | | | | | | alcohol | |
| | | | | | | | (alcoholysis | |
| | | | | | | | degree = | |
| | | | | | | | 99%) | |
| Embodiment | 97.2:2:0.8 | 5 | 1000 | 300 | 20 | 60 | Polyvinyl | 70 |
| 2-8 | | | | | | | alcohol | |
| | | | | | | | (alcoholysis | |
| | | | | | | | degree = | |
| | | | | | | | 93.5%) | |
| Embodiment | 97.2:2:0.8 | 10 | 400 | 300 | 20 | 30 | Polyvinyl | 70 |
| 2-9 | | | | | | | alcohol | |
| | | | | | | | (alcoholysis | |
| | | | | | | | degree = | |
| | | | | | | | 93.5%) | |
| Embodiment | 97.2:2:0.8 | 15 | 120 | 300 | 20 | 20 | Polyvinyl | 70 |
| 2-10 | | | | | | | alcohol | |
| | | | | | | | (alcoholysis | |
| | | | | | | | degree = | |
| | | | | | | | 93.5%) | |
| Embodiment | 97.2:2:0.8 | 40 | 80 | 300 | 20 | 7.5 | Polyvinyl | 70 |
| 2-11 | | | | | | | alcohol | |
| | | | | | | | (alcoholysis | |
| | | | | | | | degree = | |
| | | | | | | | 93.5%) | |
| Embodiment | 97.2:2:0.8 | 30 | 90 | 300 | 20 | 10 | Polyvinyl | 70 |
| 2-12 | | | | | | | alcohol | |
| | | | | | | | (alcoholysis | |
| | | | | | | | degree = | |
| | | | | | | | 93.5%) | |
| Embodiment | 97.2:2:0.8 | 50 | 80 | 300 | 20 | 6 | Polyvinyl | 70 |
| 2-13 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 100 | 100 | 5 | Polyvinyl | 70 |
| 2-14 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 120 | 50 | 6 | Polyvinyl | 70 |
| 2-15 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 150 | 50 | 7.5 | Polyvinyl | 70 |
| 2-16 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 400 | 15 | 20 | Polyvinyl | 70 |
| 2-17 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 500 | 10 | 25 | Polyvinyl | 70 |
| 2-18 | | | | | | | alcohol | |
| | | | | | | | (alcoholysis | |
| | | | | | | | degree = | |
| | | | | | | | 93.5%) | |
| Embodiment | 97.2:2:0.8 | 40 | 80 | 100 | 100 | 2.5 | Polyvinyl | 70 |
| 2-19 | | | | | | | alcohol | |
| | | | | | | | (alcoholysis | |
| | | | | | | | degree = | |
| | | | | | | | 93.5%) | |
| Embodiment | 97.2:2:0.8 | 10 | 400 | 100 | 100 | 10 | Polyvinyl | 70 |
| 2-20 | | | | | | | alcohol | |
| | | | | | | | (alcoholysis | |
| | | | | | | | degree = | |
| | | | | | | | 93.5%) | |
| Embodiment | 97.2:2:0.8 | 10 | 400 | 120 | 50 | 12 | Polyvinyl | 70 |
| 2-21 | | | | | | | alcohol | |
| | | | | | | | (alcoholysis | |
| | | | | | | | degree = | |
| | | | | | | | 93.5%) | |
| Embodiment | 97.2:2:0.8 | 5 | 400 | 300 | 20 | 60 | Polyvinyl | 70 |
| 2-22 | | | | | | | alcohol | |
| | | | | | | | (alcoholysis | |
| | | | | | | | degree = | |
| | | | | | | | 93.5%) | |
| Embodiment | 97.2:2:0.8 | 5 | 1000 | 500 | 10 | 100 | Polyvinyl | 70 |
| 2-23 | | | | | | | alcohol | |
| | | | | | | | (alcoholysis | |
| | | | | | | | degree = | |
| | | | | | | | 93.5%) | |
| Embodiment | 97.2:2:0.8 | 10 | 400 | 300 | 20 | 30 | Polyvinyl | 70 |
| 2-24 | | | | | | | alcohol | |
| | | | | | | | (alcoholysis | |
| | | | | | | | degree = | |
| | | | | | | | 93.5%) | |
| Embodiment | 97.2:2:0.8 | 35 | 50 | 300 | 20 | 8.6 | Polyvinyl | 70 |
| 2-25 | | | | | | | alcohol | |
| | | | | | | | (alcoholysis | |
| | | | | | | | degree = | |
| | | | | | | | 93.5%) | |
| Embodiment | 97.2:2:0.8 | 3 | 1100 | 300 | 20 | 100 | Polyvinyl | 70 |
| 2-26 | | | | | | | alcohol | |
| | | | | | | | (alcoholysis | |
| | | | | | | | degree = | |
| | | | | | | | 93.5%) | |
| Embodiment | 97.2:2:0.8 | 60 | 70 | 300 | 20 | 5 | Polyvinyl | 70 |
| 2-27 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 130 | 110 | 6.5 | Polyvinyl | 70 |
| 2-28 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 50 | 150 | 2.5 | Polyvinyl | 70 |
| 2-29 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 600 | 3 | 30 | Polyvinyl | 70 |
| 2-30 | | | | | | | alcohol | |
| | | | | | | | (alcoholysis | |
| | | | | | | | degree = | |
| | | | | | | | 93.5%) | |
| Embodiment | 97.2:2:0.8 | 50 | 80 | 50 | 150 | 1 | Polyvinyl | 70 |
| 2-31 | | | | | | | alcohol | |
| | | | | | | | (alcoholysis | |
| | | | | | | | degree = | |
| | | | | | | | 93.5%) | |
| Embodiment | 97.2:2:0.8 | 4 | 1050 | 500 | 10 | 125 | Polyvinyl | 70 |
| 2-32 | | | | | | | alcohol | |
| | | | | | | | (alcoholysis | |
| | | | | | | | degree = | |
| | | | | | | | 93.5%) | |
| Embodiment | 97.2:2:0.8 | 20 | 100 | 300 | 20 | 15 | Polyvinyl | 120 |
| 2-33 | | | | | | | alcohol | |
| | | | | | | | (alcoholysis | |
| | | | | | | | degree = | |
| | | | | | | | 99.5%) | |
| Embodiment | 97.2:2:0.8 | 20 | 100 | 300 | 20 | 15 | Polyvinyl | 40 |
| 2-34 | | | | | | | alcohol | |
| | | | | | | | (alcoholysis | |
| | | | | | | | degree = | |
| | | | | | | | 85%) | |

TABLE 3

| | | | | | | | Low- | Hot |
|---|---|---|---|---|---|---|---|---|
| | | | | | | | temperature | box |
| | | | | | | | discharge | test |
| | Bonding | Air | Ionic | | | | performance | pass |
| | force | permeability | impedance | T₁ | T₂ | ΔR | improvement | rate |
| | (N/m) | (s/cc) | (Ω) | (%) | (%) | (mΩ) | rate (%) | (%) |
| Embodiment | 65 | 4 | 0.001 | 2.2 | 2.3 | 14 | 22 | 100 |
| 1-2 | | | | | | | | |
| Embodiment | 67 | 5.6 | 0.0015 | 2.5 | 2.1 | 13 | 21 | 100 |
| 1-3 | | | | | | | | |
| Embodiment | 68 | 5.3 | 0.0013 | 2.4 | 2.2 | 13.3 | 21.6 | 100 |
| 2-1 | | | | | | | | |
| Embodiment | 67.5 | 5.5 | 0.00145 | 2.4 | 2.3 | 13.1 | 21.2 | 100 |
| 2-2 | | | | | | | | |
| Embodiment | 66 | 4.5 | 0.0012 | 2.2 | 2.3 | 13.7 | 21.8 | 100 |
| 2-3 | | | | | | | | |
| Embodiment | 68 | 6 | 0.0017 | 2.5 | 2.4 | 12.9 | 20.9 | 100 |
| 2-4 | | | | | | | | |
| Embodiment | 67 | 7.7 | 0.0019 | 2.5 | 2.6 | 12.6 | 20.7 | 100 |
| 2-5 | | | | | | | | |
| Embodiment | 67 | 7.8 | 0.0023 | 2.6 | 2.6 | 12.3 | 20.5 | 100 |
| 2-6 | | | | | | | | |
| Embodiment | 67 | 7.9 | 0.0025 | 2.6 | 2.7 | 12.2 | 20 | 99.5 |
| 2-7 | | | | | | | | |
| Embodiment | 44 | 13 | 0.06 | 3.2 | 3.3 | 6 | 10.2 | 92 |
| 2-8 | | | | | | | | |
| Embodiment | 45 | 12.7 | 0.05 | 3.1 | 3 | 6.1 | 13.1 | 93 |
| 2-9 | | | | | | | | |
| Embodiment | 48 | 12 | 0.044 | 3.1 | 3 | 6.6 | 13.6 | 94.4 |
| 2-10 | | | | | | | | |
| Embodiment | 50 | 11.8 | 0.046 | 3 | 3.1 | 6.5 | 13.4 | 94.2 |
| 2-11 | | | | | | | | |
| Embodiment | 56 | 11.6 | 0.045 | 3 | 3 | 6.7 | 13.6 | 94.5 |
| 2-12 | | | | | | | | |
| Embodiment | 58 | 13 | 0.062 | 3.3 | 3.2 | 5.8 | 9.9 | 91.8 |
| 2-13 | | | | | | | | |
| Embodiment | 57 | 13.5 | 0.065 | 3.3 | 3.4 | 5.9 | 9.6 | 91.5 |
| 2-14 | | | | | | | | |
| Embodiment | 57 | 13 | 0.063 | 3.3 | 3.3 | 5.8 | 9.7 | 90.5 |
| 2-15 | | | | | | | | |
| Embodiment | 55 | 12.6 | 0.054 | 3.1 | 3.2 | 5.9 | 12.3 | 92.5 |
| 2-16 | | | | | | | | |
| Embodiment | 54 | 12.4 | 0.052 | 3 | 3.2 | 6 | 12.5 | 92.7 |
| 2-17 | | | | | | | | |
| Embodiment | 52 | 13.7 | 0.066 | 3.3 | 3.4 | 5.5 | 9.5 | 91.4 |
| 2-18 | | | | | | | | |
| Embodiment | 43 | 13.2 | 0.063 | 3.4 | 3.0 | 5.5 | 9.6 | 90.8 |
| 2-19 | | | | | | | | |
| Embodiment | 54 | 13 | 0.06 | 3.3 | 3.2 | 5.6 | 10.1 | 92 |
| 2-20 | | | | | | | | |
| Embodiment | 55 | 12.7 | 0.056 | 3.1 | 3 | 5.7 | 12 | 92.1 |
| 2-21 | | | | | | | | |
| Embodiment | 55 | 12.7 | 0.055 | 3.1 | 3 | 5.8 | 12.2 | 92.3 |
| 2-22 | | | | | | | | |
| Embodiment | 55 | 13.3 | 0.065 | 3.3 | 3.4 | 5.9 | 9.6 | 91.6 |
| 2-23 | | | | | | | | |
| Embodiment | 65 | 12.8 | 0.054 | 3.3 | 3.3 | 5.9 | 12.3 | 92.5 |
| 2-24 | | | | | | | | |
| Embodiment | 41 | 14 | 0.075 | 3.5 | 3.6 | 5.1 | 9.2 | 89.5 |
| 2-25 | | | | | | | | |
| Embodiment | 67 | 16 | 0.09 | 3.7 | 3.8 | 4.85 | 8.3 | 88.8 |
| 2-26 | | | | | | | | |
| Embodiment | 42 | 15.7 | 0.085 | 3.6 | 3.7 | 4.9 | 8.6 | 89 |
| 2-27 | | | | | | | | |
| Embodiment | 53 | 13.8 | 0.071 | 3.5 | 3.7 | 5.3 | 9.4 | 89.8 |
| 2-28 | | | | | | | | |
| Embodiment | 53 | 15.4 | 0.08 | 3.7 | 3.7 | 4.95 | 8.8 | 89.2 |
| 2-29 | | | | | | | | |
| Embodiment | 52 | 13.9 | 0.074 | 3.7 | 3.6 | 5.2 | 9.3 | 89.6 |
| 2-30 | | | | | | | | |
| Embodiment | 44 | 14.1 | 0.078 | 3.5 | 3.7 | 5 | 9 | 89.4 |
| 2-31 | | | | | | | | |
| Embodiment | 66 | 14 | 0.075 | 3.5 | 3.7 | 5.2 | 9.2 | 89.4 |
| 2-32 | | | | | | | | |
| Embodiment | 54 | 12.7 | 0.055 | 3.1 | 2.7 | 5.8 | 12.3 | 92.2 |
| 2-33 | | | | | | | | |
| Embodiment | 55 | 11.6 | 0.045 | 3.1 | 2.4 | 6.7 | 13.6 | 94.4 |
| 2-34 | | | | | | | | |

The water dissolution temperature of the binder usually also affects the kinetic performance and heat resistance of the separator. As can be seen from Embodiment 1-2, Embodiment 1-3, Embodiments 2-1 to 2-7, and Embodiments 2-33 to 2-34, the separator containing a binder with a water dissolution temperature that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The specific surface area BET₁ of the first filler usually also affects the kinetic performance and heat resistance of the separator. As can be seen from Embodiment 1-2, Embodiments 2-8 to 2-13, and Embodiments 2-26 and 2-27, the separator containing a first filler with a specific surface area BET₁ that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The specific surface area BET₂ of the second filler usually also affects the kinetic performance and heat resistance of the separator. As can be seen from Embodiment 1-2, Embodiments 2-14 to 2-18, and Embodiments 2-29 and 2-30, the separator containing a second filler with a specific surface area BET₂ that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The BET₂/BET₁ ratio usually also affects the kinetic performance and heat resistance of the separator. As can be seen from Embodiment 1-2, Embodiments 2-19 to 2-24, and Embodiments 2-31 and 2-32, the separator with a BET₂/BET₁ ratio falling within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The average particle diameter of the first filler usually also affects the kinetic performance and heat resistance of the separator. As can be seen from Embodiment 1-2, Embodiments 2-8 to 2-11, and Embodiments 2-25 and 2-27, the separator containing a first filler with an average particle diameter that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The average particle diameter of the second filler usually also affects the kinetic performance and heat resistance of the separator. As can be seen from Embodiment 1-2, Embodiments 2-14 to 2-18, and Embodiments 2-28 to 2-31, the separator containing a second filler with an average particle diameter that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

TABLE 4

| | | | | | | | | | | Low- | Hot |
|---|---|---|---|---|---|---|---|---|---|---|---|
| | | | | | | | | | | temperature | box |
| | | | | | | | | | | discharge | test |
| | | | | Bonding | Air | Ionic | | | | performance | pass |
| | First | Second | | force | permeability | impedance | T₁ | T₂ | ΔR | improvement | rate |
| | filler | filler | Binder | (N/m) | (s/cc) | (Ω) | (%) | (%) | (mΩ) | rate (%) | (%) |
| Embodiment | Boehmite | Aluminum | Polyvinyl | 66 | 4.5 | 0.0012 | 2.2 | 2.3 | 13.7 | 21.8 | 100 |
| 2-3 | | oxide | alcohol | | | | | | | | |
| | | | (alcoholysis | | | | | | | | |
| | | | degree = | | | | | | | | |
| | | | 93.5%) | | | | | | | | |
| Embodiment | Aluminum | Aluminum | Polyvinyl | 63 | 5.7 | 0.0015 | 2.5 | 2.2 | 13.1 | 21.2 | 100 |
| 3-1 | oxide | oxide | alcohol | | | | | | | | |
| | | | (alcoholysis | | | | | | | | |
| | | | degree = | | | | | | | | |
| | | | 93.5%) | | | | | | | | |
| Embodiment | Titanium | Aluminum | Polyvinyl | 64 | 7.8 | 0.0020 | 2.5 | 2.7 | 12.5 | 20.5 | 100 |
| 3-2 | dioxide | oxide | alcohol | | | | | | | | |
| | | | (alcoholysis | | | | | | | | |
| | | | degree = | | | | | | | | |
| | | | 93.5%) | | | | | | | | |
| Embodiment | Boehmite | Boron | Polyvinyl | 62 | 6.1 | 0.0017 | 2.5 | 2.4 | 12.8 | 20.7 | 100 |
| 3-3 | | nitride | alcohol | | | | | | | | |
| | | | (alcoholysis | | | | | | | | |
| | | | degree = | | | | | | | | |
| | | | 93.5%) | | | | | | | | |
| Embodiment | Boehmite | Zirconium | Polyvinyl | 62 | 7.7 | 0.0019 | 2.5 | 2.6 | 12.6 | 20.6 | 100 |
| 3-4 | | oxide | alcohol | | | | | | | | |
| | | | (alcoholysis | | | | | | | | |
| | | | degree = | | | | | | | | |
| | | | 93.5%) | | | | | | | | |
| Embodiment | Boehmite | Aluminum | Hydroxy | 60 | 6.2 | 0.0017 | 2.5 | 2.5 | 12.8 | 20.9 | 100 |
| 3-5 | | oxide | methyl | | | | | | | | |
| | | | cellulose | | | | | | | | |
| | | | (weight- | | | | | | | | |
| | | | average | | | | | | | | |
| | | | molecular | | | | | | | | |
| | | | weight: 50 | | | | | | | | |
| | | | W) | | | | | | | | |
| Embodiment | Boehmite | Aluminum | Polyvinyl | 58 | 7.9 | 0.0022 | 2.6 | 2.6 | 123 | 20.5 | 100 |
| 3-6 | | oxide | formal | | | | | | | | |
| | | | (weight- | | | | | | | | |
| | | | average | | | | | | | | |
| | | | molecular | | | | | | | | |
| | | | weight: 50 | | | | | | | | |
| | | | W) | | | | | | | | |

The type of the first filler usually also affects the kinetic performance and heat resistance of the separator. As can be seen from Embodiment 2-3 and Embodiments 3-1 and 3-2, the separator containing a type of first filler that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The type of the second filler usually also affects the kinetic performance and heat resistance of the separator. As can be seen from Embodiments 2-3, 3-3, and 3-4, the separator containing a type of second filler that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

The type of the binder usually also affects the kinetic performance and heat resistance of the separator. As can be seen from Embodiments 2-3, 3-5, and 3-6, the separator containing a type of binder that falls within the range specified herein is of high adhesion and low air permeability, ionic impedance, and heat shrink ratio; and the lithium-ion batteries achieve a large decrease in the direct current resistance, a high low-temperature discharge performance improvement rate, and a high hot box test pass rate, indicating that the kinetic performance and thermal safety performance of the electrochemical device are good.

It is hereby noted that the relational terms herein such as first and second are used only to differentiate an entity or operation from another entity or operation, and do not require or imply any actual relationship or sequence between the entities or operations. Moreover, the terms “include”, “comprise”, and any variation thereof are intended to cover a non-exclusive inclusion relationship in which a process, method, object, or device that includes or comprises a series of elements not only includes such elements, but also includes other elements not expressly specified or also includes inherent elements of the process, method, object, or device.

Different embodiments of this application are described in a correlative manner. For the same or similar part in one embodiment, reference may be made to another embodiment. Each embodiment focuses on differences from other embodiments.

What is described above is merely preferred embodiments of this application, but not intended to limit the protection scope of this application. Any modifications, equivalent replacements, improvements, and the like made without departing from the spirit and principles of this application still fall within the protection scope of this application.

What is claimed is:

1. A separator, comprising a substrate and a ceramic coating layer disposed on at least one surface of the substrate; wherein the ceramic coating layer comprises a first filler, a second filler, and a binder; a mass ratio between the first filler, the second filler, and the binder is (88.5 to 99):(0.5 to 10):(0.5 to 1.5); and an ionic impedance of the ceramic coating layer is 0.001Ω to 0.15 Ω.

2. The separator according to claim 1, wherein the mass ratio between the first filler, the second filler, and the binder is (96 to 98):(1 to 3.5):(0.5 to 1.5).

3. The separator according to claim 1, wherein the ionic impedance of the ceramic coating layer is 0.001Ω to 0.1 Ω.

4. The separator according to claim 1, wherein a specific surface area of the first filler is BET₁, a specific surface area of the second filler is BET₂, and the separator satisfies at least one of the following conditions (1) to (4):
$$5 {m}^{2} / g \leq {BET}_{1} \leq 50 {m}^{2} / g ; \qquad ( 1 )$$
$$100 {m}^{2} / g \leq {BET}_{2} \leq 500 {m}^{2} / g ; \qquad ( 2 )$$
$$2.5 \leq {BET}_{2} / {BET}_{1} \leq 100 ; or \qquad ( 3 )$$
(4) a water dissolution temperature of the binder is 50° C. to 100° C.

5. The separator according to claim 4, wherein the separator satisfies at least one of the following conditions (1) to (4):
$$15 {m}^{2} / g \leq {BET}_{1} \leq 30 {m}^{2} / g ; \qquad ( 1 )$$
$$150 {m}^{2} / g \leq {BET}_{2} \leq 400 {m}^{2} / g ; \qquad ( 2 )$$
$$12 \leq {BET}_{2} / {BET}_{1} \leq 50 ; or \qquad ( 3 )$$
(4) the water dissolution temperature of the binder is 50° C. to 80° C.

6. The separator according to claim 1, wherein an average particle diameter of the first filler is Dv50ₐ, and 80 nm≤Dv50ₐ≤1000 nm.

7. The separator according to claim 6, wherein 80 nm≤Dv50ₐ≤400 nm.

8. The separator according to claim 1, wherein an average particle diameter of the second filler is Dv50_{b}, and 10 nm≤Dv50_{b}≤100 nm.

9. The separator according to claim 8, wherein 15 nm≤Dv50_{b}≤50 nm.

10. The separator according to claim 1, wherein a material of the first filler and a material of the second filler each independently comprise at least one of boehmite, aluminum oxide, zirconium oxide, titanium dioxide, magnesium oxide, mullite, silicon carbide, silicon nitride, boron nitride, or aluminum nitride; and
a material of the binder comprises at least one of polyvinyl alcohol, hydroxymethyl cellulose, or polyvinyl formal.

11. The separator according to claim 1, wherein a bonding force of the ceramic coating layer is 30 N/m to 100 N/m.

12. The separator according to claim 1, wherein a bonding force of the ceramic coating layer is 40 N/m to 80 N/m.

13. The separator according to claim 1, wherein a heat shrink ratio of the separator along a length direction of the separator is 1% to 5%, and a heat shrink ratio of the separator along a width direction of the separator is 1% to 5%.

14. An electrochemical device, wherein the electrochemical device comprises a separator;
the separator comprises a substrate and a ceramic coating layer disposed on at least one surface of the substrate; wherein the ceramic coating layer comprises a first filler, a second filler, and a binder; a mass ratio between the first filler, the second filler, and the binder is (88.5 to 99):(0.5 to 10):(0.5 to 1.5); and an ionic impedance of the ceramic coating layer is 0.001Ω to 0.15 Ω.

15. The electrochemical device according to claim 14, wherein the mass ratio between the first filler, the second filler, and the binder is (96 to 98):(1 to 3.5):(0.5 to 1.5).

16. The electrochemical device according to claim 14, wherein the ionic impedance of the ceramic coating layer is 0.001Ω to 0.1 Ω.

17. The electrochemical device according to claim 14, wherein a specific surface area of the first filler is BET₁, a specific surface area of the second filler is BET₂, and the separator satisfies at least one of the following conditions (1) to (4):
$$5 {m}^{2} / g \leq {BET}_{1} \leq 50 {m}^{2} / g ; \qquad ( 1 )$$
$$100 {m}^{2} / g \leq {BET}_{2} \leq 500 {m}^{2} / g ; \qquad ( 2 )$$
$$2.5 \leq {BET}_{2} / {BET}_{1} \leq 100 ; or \qquad ( 3 )$$
(4) a water dissolution temperature of the binder is 50° C. to 100° C.

18. The electrochemical device according to claim 14, wherein the separator satisfies at least one of the following conditions (1) to (4):
$$15 {m}^{2} / g \leq {BET}_{1} \leq 30 {m}^{2} / g ; \qquad ( 1 )$$
$$150 {m}^{2} / g \leq {BET}_{2} \leq 400 {m}^{2} / g ; \qquad ( 2 )$$
$$12 \leq {BET}_{2} / {BET}_{1} \leq 50 ; or \qquad ( 3 )$$
(4) the water dissolution temperature of the binder is 50° C. to 80° C.

19. The electrochemical device according to claim 14, wherein an average particle diameter of the first filler is Dv50ₐ, and 80 nm≤Dv50ₐ≤1000 nm.

20. An electronic device, wherein the electronic device comprises the electrochemical device according to claim 14.
